(19) United States
(12) Patent Application Publication
(10) Pub. No.: US 2013/0038141 A1
(43) Pub. Date: Feb. 14, 2013

(54) FAN CONTROL CIRCUIT

(71) Applicants: TING GE, Shenzhen City (CN); YING-BIN FU, Shenzhen City (CN); YA-JUN PAN, Shenzhen City (CN)

(72) Inventors: TING GE, Shenzhen City (CN); YING-BIN FU, Shenzhen City (CN); YA-JUN PAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/304,375

(22) Filed: Nov. 24, 2011

(30) Foreign Application Priority Data
Aug. 9, 2011 (CN) 201110227153.6

(51) Int. Cl. H01H 47/00

(52) U.S. Cl. 307/130

(57) ABSTRACT

A fan control circuit is used to control first and second fans to be powered on at different time after receiving a power good (PWGD) signal from a motherboard. The fan control circuit includes a first control circuit, a delay circuit, and a second control circuit. The first control circuit and the delay circuit are connected to the motherboard to receive the PWGD signal. The first control circuit powers the first fan after receiving the PWGD signal. The delay circuit delays the received PWGD signal, and outputs the delayed PWGD signal to the second control circuit after a delay time. The second control circuit powers the second fan after receiving the delayed PWGD signal.

### 1. TECHNICAL FIELD

The present disclosure relates to control circuits, and particularly, to a fan control circuit.

### 2. DESCRIPTION OF RELATED ART

In a server, many fans dissipate heat from the server. When a server is powered on, all of the fans rotate at the full speed, which leads to the system power supply being unstable.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is a block diagram of an exemplary embodiment of a fan control circuit, wherein the fan control circuit includes a first control circuit, a delay circuit, and a second control circuit.

FIG. 2 is a circuit diagram of the first control circuit of FIG. 1.

FIG. 3 is a circuit diagram of the delay circuit of FIG. 1.

FIG. 4 is a circuit diagram of the second control circuit of FIG. 1.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

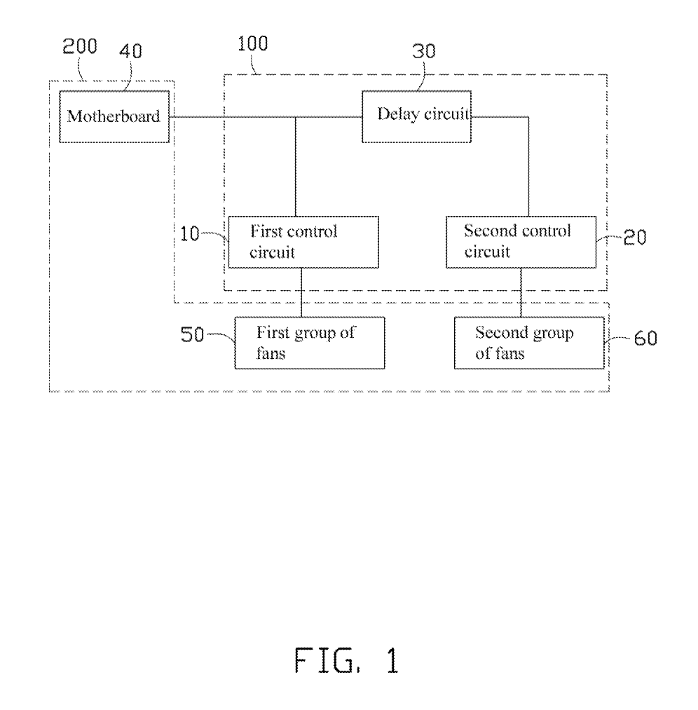

Referring to FIG. 1, an embodiment of a fan control circuit 100 is used to control a first group of fans 50 and a second group of fans 60 of a server 200 to be powered on at different time. The fan control circuit 100 includes a first control circuit 10, a second control circuit 20, and a delay circuit 30. The first control circuit 10 and the delay circuit 30 are connected to a motherboard 40 of the server 200 to receive a power good (PWGD) signal from the motherboard 40. The delay circuit 30 delays the PWGD signal for a delay time. The delay circuit 30 is connected to the second control circuit 20 to output the delayed PWGD signal to the second control circuit 20. The first control circuit 10 is connected to the first group of fans 50 to power the first group of fans 50. The second control circuit 20 is connected to the second group of fans 60 to power the second group of fans 60.

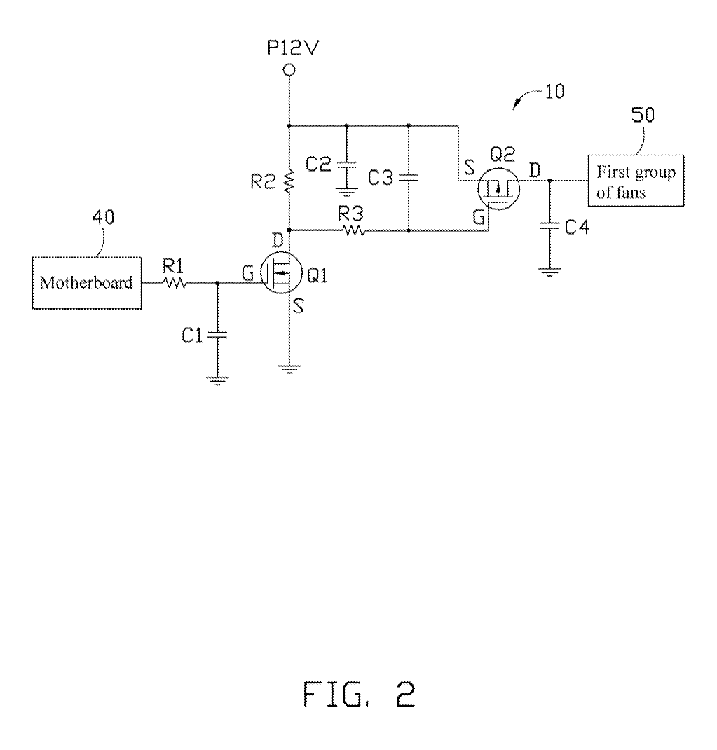

Referring to FIG. 2, the first control circuit 10 includes resistors R1-R3, capacitors C1-C4, and transistors Q1-Q2. In the embodiment, the transistor Q1 is an n-channel metallic oxide semiconductor field effect transistor (MOSFET), and the transistor Q2 is a p-channel MOSFET. A first terminal of the resistor R1 is connected to the motherboard 40 to receive the PWGD signal from the motherboard 40. A second terminal of the resistor R is grounded through the capacitor C1, and is connected to a gate of the transistor Q1. A source of the transistor Q1 is grounded. A drain of the transistor Q1 is connected to a power source P12V through the resistor R2, and is connected to a gate of the transistor Q2 through the resistor R3. A source of the transistor Q2 is connected to the power source P12V. The capacitor C3 is connected between the source and gate of the transistor Q2. A drain of the transistor Q2 is connected to the first group of fans 50 to output a first work voltage to the first group of fans 50. The capacitor C2 is connected between the power source P12V and ground. The capacitor C4 is connected between the drain of the transistor Q2 and ground.

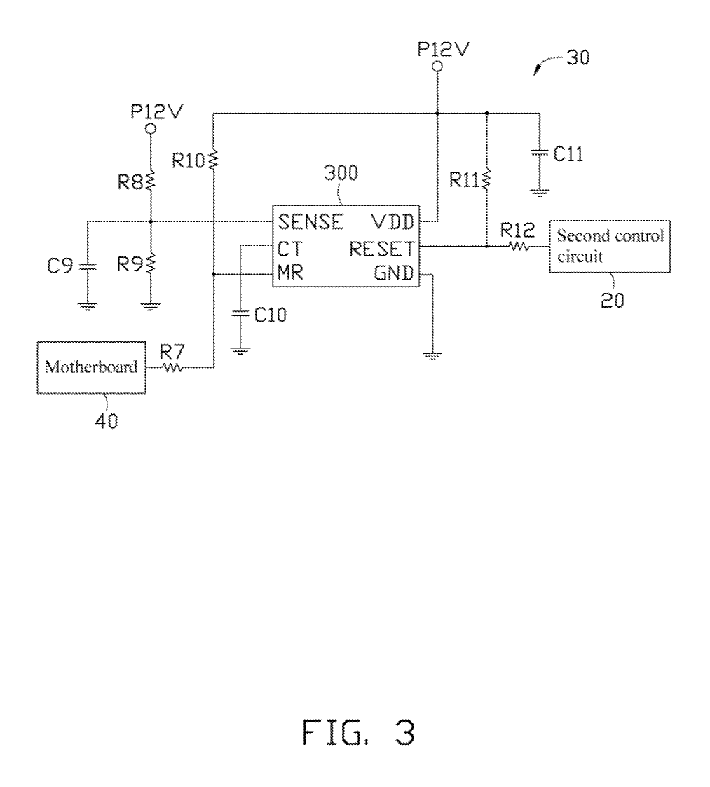

Referring to FIG. 3, the delay circuit 30 includes resistors R7-R12, capacitors C9-C11, and a delay chip 300. The delay chip 300 includes a voltage detection pin SENSE, a delay pin CT, a signal input pin MR, a reset output pin RESET, a voltage pin VDD, and a ground pin GND. The signal input pin MR is connected to the motherboard 40 through the resistor R7 to receive the PWGD signal from the motherboard 40, and is connected to the power source P12V through the resistor R10. The delay pin CT is grounded through the capacitor C10. The resistors R8 and R9 are connected between the power source P12V and ground in series. A node between the resistor R8 and resistor R9 is connected to the voltage detection pin SENSE, and is also grounded through the capacitor C9. The reset output pin RESET is connected to the second control circuit 20 through the resistor R12 to output the delayed PWGD signal to the second control circuit 20. The ground pin GND is grounded. The capacitor C11 is connected between the power source P12V and ground. The resistor R11 is connected between the power source P12V and the reset output pin RESET.

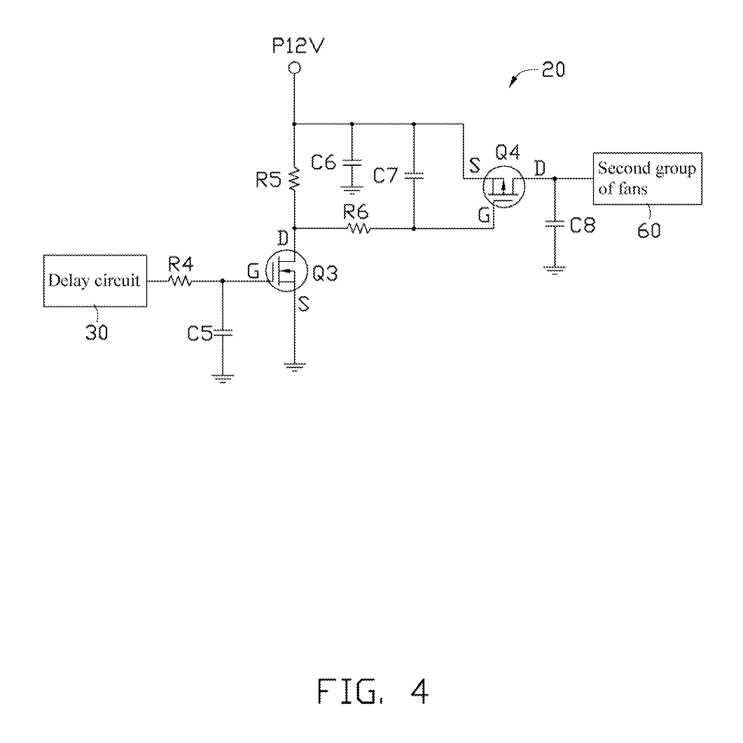

Referring to FIG. 4, the second control circuit 20 includes resistors R4-R6, capacitors C5-C8, and transistors Q3 and Q4. In the embodiment, the transistor Q3 is an n-channel MOSFET, and the transistor Q4 is a p-channel MOSFET. A first terminal of the resistor R4 is connected to the reset output pin RESET of the delay chip 300 through the resistor R12, to receive the delayed PWGD signal from the delay circuit 30. A second terminal of the resistor R4 is grounded through the capacitor C5, and is connected to a gate of the transistor Q3. A source of the transistor Q3 is grounded. A drain of the transistor Q3 is connected to the power source P12V through the resistor R5, and is connected to a gate of the transistor Q4 through the resistor R6. A source of the transistor Q4 is connected to the power source P12V. The capacitor C7 is connected between the source and the gate of the transistor Q4. The capacitor C6 is connected between the power source P12V and ground. A drain of the transistor Q4 is connected to the second group of fans 60 to output a second work voltage to the second group of fans 60, and is grounded through the capacitor C8.

When the motherboard 40 is powered on, the motherboard 40 outputs the PWGD signal which is a logical 1 high level signal to the first control circuit 10 and the delay circuit 30. The gate of the transistor Q1 and the signal input pin MR of the delay chip 300 receive the high level signal. The transistor Q1 is turned on. The gate of the transistor Q2 receives a logical 0 low level signal. The transistor Q2 is turned on. The drain of the transistor Q2 outputs a first work voltage to the first group of fans 50. At the same time, the delay chip 300 delays the received high level signal for the delay time. The reset output pin RESET outputs the delayed high level after the delay time to the gate of the transistor Q3. The transistors Q3 and Q4 are turned on. The drain of the transistor Q4 outputs the second work voltage to the second group of fans 60. Therefore, the first and second groups of fans 50 and 60 are started at different time after the motherboard 40 is powered on.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A fan control circuit to control a first fan and a second fan to be powered on at different time, the fan control circuit comprising:
a first control circuit comprising:
a first electronic switch comprising a control terminal connected to a motherboard to receive a power good (PWGD) signal from the motherboard, a first terminal grounded, and a second terminal connected to a power source through a first resistor; and
a second electronic switch comprising a control terminal connected to the second terminal of the first electronic switch, a first terminal connected to the power source, and a second terminal connected to the first fan;
a delay circuit connected to the motherboard to receive the PWGD signal, delay the PWGD signal for a delay time, and then output the delayed PWGD signal; and
a second control circuit comprising:
a third electronic switch comprising a control terminal connected to the delay circuit to receive the delayed PWGD signal, a first terminal grounded, and a second terminal connected to the power source through a second resistor; and
a fourth electronic switch comprising a control terminal connected to the second terminal of the third electronic switch, a first terminal connected to the power source, and a second terminal connected to the second fan;
wherein the first and third electronic switches are turned on in response to the corresponding control terminals receiving high level signals, the second and fourth electronic switches are turned on in response to the corresponding control terminals receiving low level signals.

2. The fan control circuit of claim 1, wherein the first and third electronic switches are n-channel metal oxide semiconductor field effect transistors (MOSFETs), the second and fourth electronic switches are p-channel MOSFETs, the control terminals, the first terminals, and the second terminals of the first to fourth electronic switches are respectively the gates, the sources, and the drains of the MOSFETs.

3. The fan control circuit of claim 1, wherein the delay circuit comprises a first capacitor and a delay chip, the delay chip comprises a signal input pin connected to the motherboard to receive the PWGD signal, a reset output pin, a voltage detection pin connected to the power source, a power pin connected to the power source, a ground pin grounded, a delay pin grounded through the first capacitor, wherein when the signal input pin receives the PWGD signal, the reset output pin outputs the delayed PWGD signal after the delay time to the control terminal of the third transistor.

4. The fan control circuit of claim 3, wherein the delay circuit further comprises a second capacitor, a third resistor, and a fourth resistor, the third and fourth resistors are connected between the power source and ground in series, a node between the third and fourth resistor is connected to the voltage detection pin of the delay chip, and is grounded through the second capacitor.

5. A server assembly comprising:
a first fan;
a second fan;
a motherboard to output a high level power good (PWGD) signal after being powered on;
a fan control circuit to control the first and second fans to be powered on at different time, the fan control circuit comprising:
a first control circuit comprising:
a first electronic switch comprising a control terminal connected to the motherboard to receive the PWGD signal, a first terminal grounded, and a second terminal connected to a power source through a first resistor; and
a second electronic switch comprising a control terminal connected to the second terminal of the first electronic switch, a first terminal connected to the power source, and a second terminal connected to the first fan;
a delay circuit connected to the motherboard to receive the PWGD signal, delay the PWGD signal for a delay time, and then output the delayed PWGD signal; and
a second control circuit comprising:
a third electronic switch comprising a control terminal connected to the delay circuit to receive the delayed PWGD signal, a first terminal grounded, and a second terminal connected to the power source through a second resistor; and
a fourth electronic switch comprising a control terminal connected to the second terminal of the third electronic switch, a first terminal connected to the power source, and a second terminal connected to the second fan;
wherein the first and third electronic switches are turned on in response to the corresponding control terminals receiving high level signals, the second and fourth electronic switches are turned on in response to the corresponding control terminals receiving low level signals.

6. The server assembly of claim 5, wherein the first and third electronic switches are n-channel metallic oxide semiconductor field effect transistors (MOSFETs), the second and fourth electronic switches are p-channel MOSFETs, the control terminals, the first terminals, and the second terminals of the first to fourth electronic switches are respectively the gates, the sources, and the drains of the MOSFETs.

7. The server assembly of claim 5, wherein the delay circuit comprises a first capacitor and a delay chip, the delay chip comprises a signal input pin connected to the motherboard to receive the PWGD signal, a reset output pin, a voltage detection pin connected to the power source, a power pin connected to the power source, a ground pin grounded, a delay pin grounded through the first capacitor, wherein when the signal input pin receives the PWGD signal, the reset output pin outputs the delayed PWGD signal after the delay time to the control terminal of the third transistor.

8. The server assembly of claim 7, wherein the delay circuit further comprises a second capacitor, a third resistor, and a fourth resistor, the third and fourth resistors are connected between the power source and ground in series, a node between the third and fourth resistor is connected to the voltage detection pin of the delay chip, and is grounded through the second capacitor.
